(19) United States
(12) Patent Application Publication
(10) Pub. No.: US 2006/0185469 A1
(43) Pub. Date: Aug. 24, 2006

(54) Pedal for motorized vehicle

(75) Inventor: Roderic Alan Schlabach, Goshen, IN (US)

Correspondence Address: CTS CORPORATION, 905 W. BLVD. N, ELKHART, IN, 46514, US

(73) Assignee: CTS Corporation

(21) Appl. No.: 11/064,978

(22) Filed: Feb. 24, 2005

(51) Int. Cl. G05G 1/14

(52) U.S. Cl. 74/560

(57) ABSTRACT

A pedal assembly that provides a repeatable response force between different pedal assemblies by providing at least one of a wear surface or a pivotal shoe on a brake pad that will contact a portion of the pedal arm. The pedal assembly includes a housing, an elongated pedal arm having a rotatable drum defining a braking surface and rotatably mounted in the housing, the pedal arm being movable between an idle, first position and a second position, a brake pad assembly having a pivoting base and a contact portion pivotally mounted to the base, the contact portion having a contact surface adapted to frictionally engage the braking surface, and a biasing device operably coupled to the pedal arm and the brake pad assembly for urging the contact surface into frictional engagement with the braking surface.

### CROSS REFERENCE TO RELATED APPLICATIONS

This application is related to pending U.S. patent application Ser. No. 10/854,837, filed on May 27, 2004. The contents of which are herein incorporated by reference.

### FIELD OF THE INVENTION

This invention relates to a pedal mechanism. In particular, the pedal may be an accelerator pedal in a vehicle.

### BACKGROUND OF THE INVENTION

Automobile accelerator pedals have conventionally been linked to engine fuel subsystems by a cable, generally referred to as a Bowden cable. While accelerator pedal designs vary, the typical return spring and cable friction together create a common and accepted tactile response for automobile drivers. For example, friction between the Bowden cable and its protective sheath otherwise reduce the foot pressure required from the driver to hold a given throttle position. Likewise, friction prevents road bumps felt by the driver from immediately affecting throttle position.

Efforts are underway to replace the mechanical cable-driven throttle systems with a more fully electronic, sensor-driven approach. With the fully electronic approach, a position sensor reads the position of the accelerator pedal and outputs a corresponding position signal for throttle control. A sensor-based approach is especially compatible with electronic control systems in which accelerator pedal position is one of several variables used for engine control.

Although such drive-by-wire configurations are technically practical, drivers generally prefer the feel, i.e., the tactile response, of conventional cable-driven throttle systems. Designers have therefore attempted to address this preference with mechanisms for emulating the tactile response of cable-driven accelerator pedals. For example, U.S. Pat. No. 6,360,631 Wortmann et al. is directed to an accelerator pedal with a plunger subassembly for providing a hysteresis effect.

In this regard, prior art systems are either too costly or inadequately emulate the tactile response of conventional accelerator pedals. One such problem is small variations in manufacturing may result in widely varying friction resulting in widely varying feel and feedback to the driver. FIGS. 15A and 15B show how variations in manufacturing result in different feedback forces being felt by a driver. Both FIGS. 15A and 15B show a brake pad 244 which contacts a drum 229 of the pedal lever. More specifically, the drum 229 rotates as shown by arrow 230 when the pedal moves. A spring 49 is connected between the pedal arm and the brake pad 244 to provide a force F_{S}. The brake pad 244 pivots at effective pivot point 246 in an attempt to bring contact surface 270 into contact with the outer surface 249 of drum 229. Brake pad 244 slides at point 245. However, due to manufacturing tolerances, the contact surface 270 does not mate flush against the drum surface 249. As a result, only a point or line of contact 231 exists where the surfaces 270, 249 are in contact. As shown in FIG. 15A the point of contact 231 between the brake pad 244 and drum 229 is at the top of the brake pad contact surface 270. As shown in FIG. 15B the point of contact 232 between the brake pad 244 and drum 229 is at the bottom of the brake pad contact surface 270. The difference in frictional force between the devices of FIGS. 15A and 15B is symbolically shown. Specifically, the lever ratio equals the length L_{S} divided by the normal-friction length L_{N}. The normal force F_{N} causes a friction force that provides feel to the driver. The normal force is calculated by multiplying the spring force F_{S} by the lever ratio (L_{S}/L_{N}). The spring force F_{S} and spring length L_{S} are typically constant. However, the normal-friction length L_{N} changes based on the point of contact. The normal-friction length L_{N} is greater in FIG. 15B than in FIG. 15A, which results in FIG. 15B having less normal force F_{N}. The driver will feel less force from the brake pad 244 in FIG. 15B than from the FIG. 15A brake pad. It is desirable to provide a more predicable feedback force or feel to a driver. Thus, there continues to be a need for a cost-effective, electronic accelerator pedal assembly having the feel of cable-based systems and providing adequate, predictable feedback to the driver.

### SUMMARY

The accelerator pedal assembly includes a housing, an elongated pedal arm terminating at one end in a rotatable drum defining a curved braking surface, a brake pad assembly having a curved contact surface substantially complementary to the braking surface and a bias spring device operably situated between the pedal arm and the brake pad. The pedal arm is rotatably mounted to the housing such that the curved braking surface rotates as the pedal moves between an idle position to an open throttle position. The brake pad assembly defines a primary pivot axis and is pivotably mounted for frictional engagement with the braking surface. The brake pad assembly includes a portion adapted to provide a given force to the user regardless of manufacturing tolerances. The bias spring serves to urge the contact surface of the brake pad into frictional engagement with the braking surface of the drum. In an embodiment, the brake pad assembly has a contact portion pivotally mounted to a base. The contact portion is adapted to frictionally engage the drum braking surface. In an embodiment, the base has a projection and the contact portion includes a recess adapted to receive the projection. In an embodiment, the recess of the contact portion is larger than the projection such that the contact portion is free to pivot in any direction. In an embodiment, the recess and projection form a press fit such that the contact portion pivots in a direction substantially tangential to the braking surface of the drum. In an embodiment, the base includes a first web connected at an inward first end to the contact portion and a second web connected at an inward first end to the contact portion. In an embodiment, the contact portion includes a cavity inward of the first ends of the first and second web. In an embodiment, base includes a projection aligned with the cavity. The contact portion includes a first arm extending in a first direction from the first end of the first web and a second arm extending in a second direction from the first end of the second web, the first arm being spaced from the first web, and the second arm being spaced from the second web. In an embodiment, the contact surface of the contact portion pivots such that it substantially mates to the braking surface. In an embodiment, the contact surface has at least 75% of its surface in contact with the braking surface with the pedal arm moved from the first, idle position. In an embodiment, the contact surface has a first substantially constant radius of curvature. In an embodiment, the contact surface has a second substantially constant radius of curvature. In an embodiment, the braking surface has a substantially constant radius of curvature substantially equal to at least one of the first or second substantially constant radius of curvatures of the contact surface. In an embodiment, the contact portion includes a wear surface adapted to conform to the braking surface over time such that a normal friction force moves to a given center value over time. In an embodiment, the brake pad assembly includes opposed trunnions adapted to mount on the housing and define a primary pivot axis.

In an embodiment, the pedal arm carries a magnet and a Hall effect position sensor is secured to the housing and responsive to the movement of the magnet for providing an electrical signal representative of pedal displacement. These and other objects, features and advantages will become more apparent in light of the text, drawings and claims.

### BRIEF DESCRIPTION OF THE DRAWINGS

FIG. 1 is an exploded isometric view of the accelerator pedal assembly of an embodiment of the present invention.

FIG. 2 is an enlarged cross-sectional view of the pedal assembly shown in FIG. 1.

FIG. 3 is a cross-sectional view of the pedal assembly showing the foot pedal and Hall effect position sensors.

FIG. 4 is an enlarged side, cross-sectional view of the accelerator pedal assembly according to the present invention.

FIG. 5 is an isometric view of the brake pad part of the accelerator pedal assembly.

FIG. 6 is a side view of an embodiment of the brake pad of the accelerator pedal assembly.

FIG. 7 is a top, plan view of the brake pad of the accelerator pedal assembly.

FIGS. 8A through 8D are force-displacement graphs mapped to simplified schematics illustrating the operation of accelerator pedal assemblies according to the present invention.

FIGS. 9A through 9C are force diagrams demonstrating the tunable tactile response of accelerator pedals according to the present invention.

FIG. 10 is an enlarged side view of an embodiment of the brake pad of the accelerator pedal assembly.

FIG. 11 is an enlarged side view of an embodiment of the brake pad of the accelerator pedal assembly.

FIG. 12 is an enlarged side view of an embodiment of the brake pad of the accelerator pedal assembly.

FIG. 13 is an enlarged side view of an embodiment of the brake pad of the accelerator pedal assembly.

FIG. 14 is an enlarged side view of an embodiment of the brake pad of the accelerator pedal assembly.

FIG. 15A is a side view of a prior art brake pad of the accelerator pedal assembly.

### DETAILED DESCRIPTION

While this invention is susceptible to embodiment in many different forms, this specification and the accompanying drawings disclose only preferred forms as examples of the invention. The invention is not intended to be limited to the embodiments so described. The scope of the invention is identified in the appended claims.

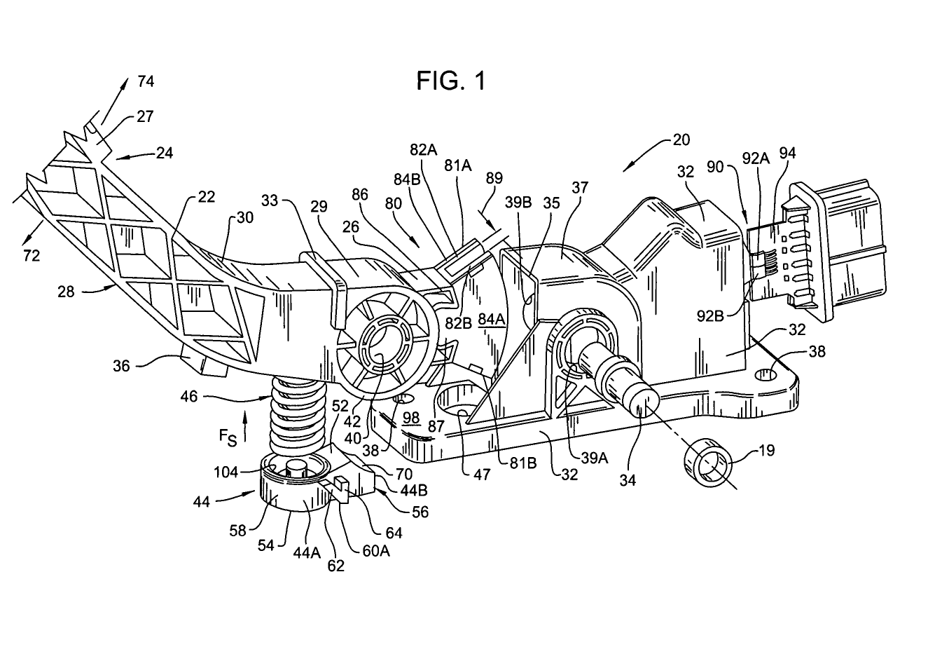

Referring to FIG. 1, a non-contacting accelerator pedal assembly 20 according to an embodiment of the present invention includes a housing 32, a pedal arm 22 rotatably mounted to housing 32, a brake pad assembly 44 and a bias spring device 46. The labels “pedal beam” or “pedal lever” also apply to pedal arm 22. Likewise, brake pad assembly 44 may be referred to as a “body” or “braking lever.” Pedal arm 22 has a footpad 27 at one end and terminates at its opposite proximal end 26 in a drum portion 29 that presents a curved, convex braking (or drag) surface 42. Pedal arm 22 has a forward side 28 nearer and facing the front of the car and a rearward side 30 nearer the driver and facing the rear of the car. Footpad 27 may be integral with the pedal lever 22 or articulating and rotating at its connection at the lower end 24. Braking surface 42 of pedal lever 22 preferably has the curvature of a circle of a radius R1 which extends from the center of opening 40, which is central to the drum portion 29 of assembly 20. A non-circular curvature for braking surface is also contemplated. In an embodiment, as illustrated, surface 42 is curved and convex with a substantially constant radius of curvature. In alternate embodiments, surface 42 has a varying radius of curvature.

Pedal arm 22 pivots from housing 32 via an axle connection through drum 29 such that drum 29 and its contact surface 42 rotate as pedal arm 22 is moved. Spring device 46 biases pedal arm 22 towards the idle position, e.g., upwardly as shown in FIG. 1. Brake pad assembly 44 has a base 44A and a contact portion 44B. The base 44A is positioned to receive spring device 46. Contact portion 44B includes a contact surface 70 that is movably into contact with drum 29. Contact surface 70 is adapted to provide a more complete contact to the drum regardless of fabrication tolerances to assembly tolerances. Brake pad assembly 44 is pivotally mounted to housing 32 such that the contact surface 70 is urged against braking surface 42 as pedal arm 22 is depressed, e.g., moved downwardly as shown in FIG. 1.

Pedal arm 22 carries a magnet subassembly 80 for creating a magnetic field that is detected by redundant Hall effect sensors 92A and 92B which are secured in housing 32. Acting together, magnet 80 and sensors 92 provide a signal representative of pedal displacement.

It should be understood that a Hall effect sensor with magnet is representative of a number of sensor arrangements available to measure the displacement of pedal arm 22 with respect to housing 32 including other optical, mechanical, electrical, magnetic and chemical means. Specifically contemplated is a contacting variable resistance position sensor.

In embodiments as illustrated, housing 32 also serves as a base for the mounted end 26 of pedal arm 22 and for sensors 92. Proximal end 26 of pedal arm 22 is pivotally secured to housing 32 with axle 34. More specifically, drum portion 29 of pedal arm 22 includes an opening 40 for receiving axle 34, while housing 32 has a hollow portion 37 with corresponding openings 39A and 39B also for receiving axle 34. Axle 34 is narrowed at its ends where it is collared by a bearing journal 19.

The base 44A of brake pad 44 includes a top 52 which is relatively flat, a bottom 54 which consists of two flat planes 114 and 112 intersecting to a ridge 110, a front face 56 which is substantially flat, and a circular back face 58 in an embodiment. Base 44A also has opposed trunnions 60A and 60B (also called outriggers or flanges) to define a primary pivot axis positioned between spring device 46 and contact surface 70. Contact surface 70 of contact portion 44B is situated on one side of this pivot axis and a donut-shaped socket 104 for receiving one end of bias spring 46 is provided on the other side in the base 44A.

Contact surface 70 of contact portion 44B is substantially complementary to braking surface 42. In the preferred embodiment, as illustrated, contact surface 70 is curved and concave with a substantially constant radius of curvature. In alternate embodiments, braking surface has a varying radius of curvature. The frictional engagement between contact surface 70 and braking surface 42 may tend to wear either surface. The shape of contact surface 42 may be adapted to reduce or accommodate wear.

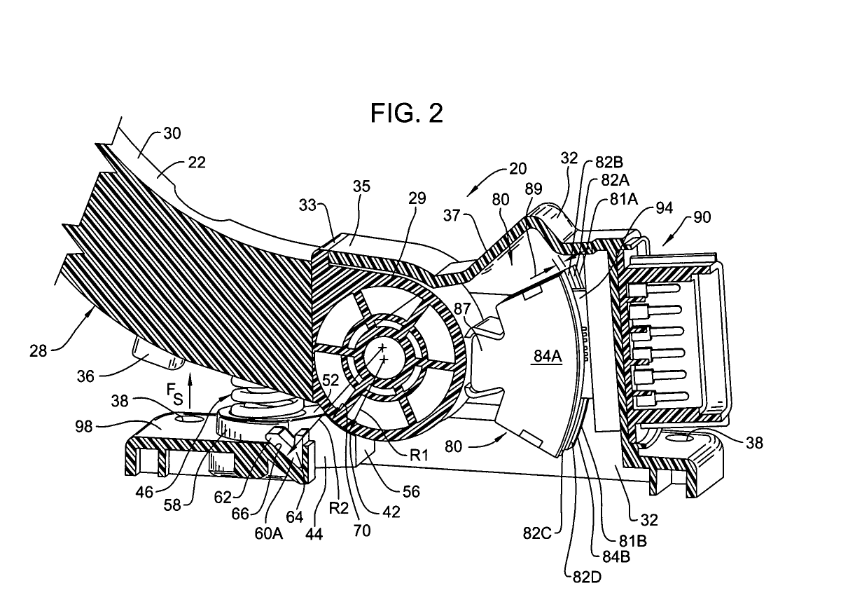

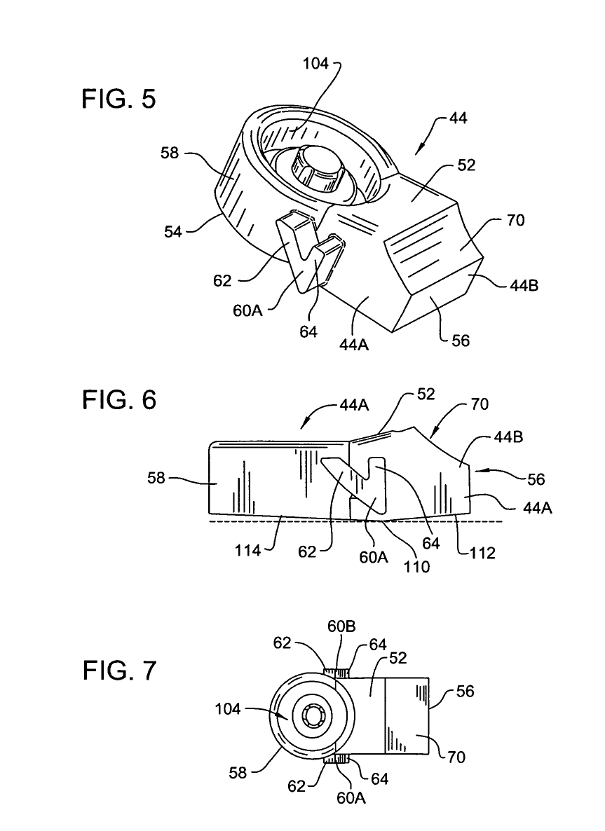

Referring now also to FIGS. 2 through 6, housing 32 is provided with spaced cheeks 66 for slidably receiving the trunnions 60A and 60B. Trunnions 60A and 60B are substantially U-shaped and have an arc-shaped portion 62 and a rectilinear (straight) portion 64. Brake pad assembly 44 pivots over cheeks 66 at trunnions 60A and 60B. As pedal arm 22 is moved in a first direction 72 (accelerate in the case of a accelerator pedal or brake in the case of a brake pedal) or the other direction 74 (decelerate or non-brake, respectively), the force Fs within compression spring 46 increases or decreases, respectively. Brake pad assembly 44 is moveable in response to the spring force Fs.

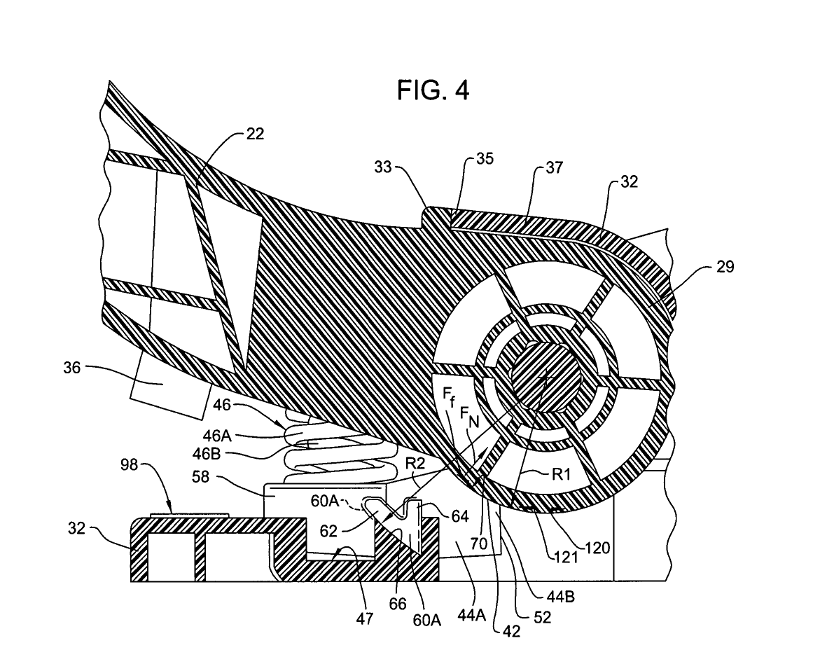

As pedal arm 22 moves towards the non-active, e.g., idle/decelerate, position (direction 74), the resulting drag between braking surface 42 and contact surface 70 urges brake pad assembly 44 towards a position in which trunnions 60A and 60B are higher on cheeks 66. This change in position is represented with phantom trunnions in FIG. 4. Although FIG. 4 depicts a change in position with phantom trunnions to aid in understanding the invention, movement of brake pad assembly 44 may not be visibly detectable. As pedal arm 22 is depressed (direction 72), the drag between braking surface 42 and contact surface 70 draws brake pad assembly 44 further into hollow portion 37. The sliding motion of brake pad assembly 44 is gradual and can be described as a “wedging” effect that either increases or decreases the force urging contact surface 70 into braking surface 22.

This directionally dependent hysteresis is desirable in that it approximates the feel of a conventional mechanically-linked accelerator pedal.

When pedal force on arm 22 is increased, brake pad assembly 44 is urged forward on cheeks 66 by the frictional force created on contact surface 70 as braking surface 42 rotates forward (direction 120 in FIG. 4). This urging forward of brake pad assembly 44 likewise urges trunnions 60A and 60B lower on cheeks 66 such that the normal, contact force of contact surface 70 into braking surface 42 is relatively reduced. When pedal force on arm 22 is reduced, the opposite effect is present: the frictional, drag force between brake pad assembly 44 and braking surface 42 urges brake pad assembly 44 backward on cheeks 66 (direction 121 in FIG. 4). This urging backward of brake pad assembly 44 urges trunnions 60A and 60B higher on cheeks 66 such that the normal direction, contact force between braking surface 42 and contact surface 70 is relatively increased. The relatively higher contact force present as the pedal force on arm 22 decreases allows a driver to hold a given throttle position with less pedal force than is required to move the pedal arm for acceleration.

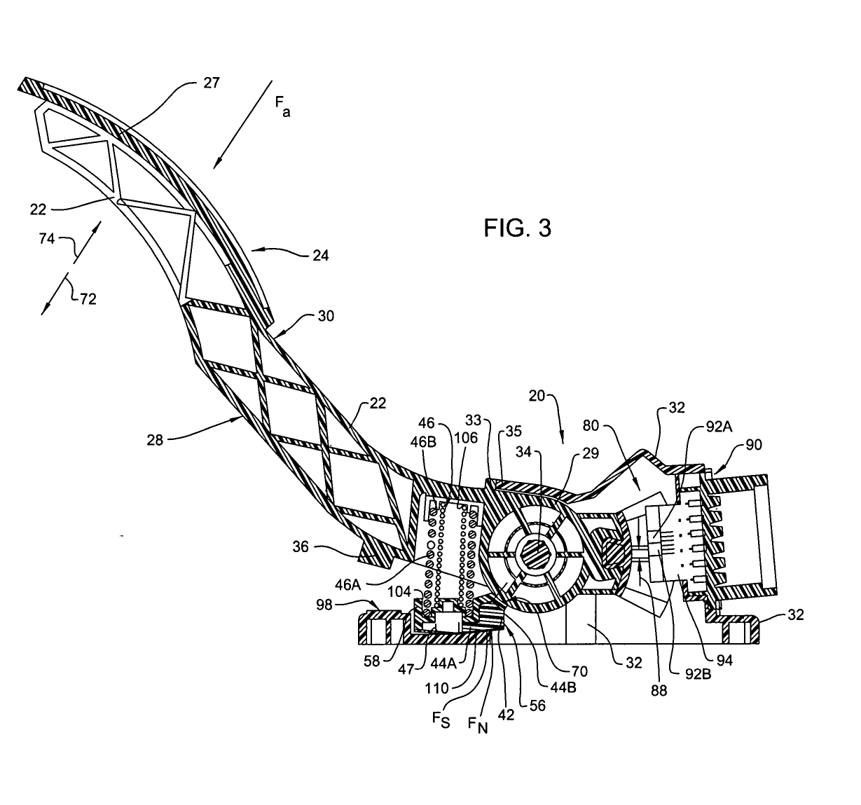

Bias spring device 46 is situated within a recess 106 in pedal lever 22 (FIG. 3) and between recess 106 and a receptacle 104 in base 44A of brake pad assembly 44. Spring device 46 includes two, redundant coil springs 46A and 46B in a concentric orientation, one spring nestled within the other. This redundancy is provided for improved reliability, allowing one spring to fail or flag without disrupting the biasing function. It is preferred to have redundant springs and for each spring to be capable—on its own—of returning the pedal lever 22 to its idle position.

Also for improved reliability, brake pad assembly 44 is provided with redundant pivoting (or rocking) structures. In addition to the primary pivot axis defined by trunnions 60A and 60B, brake pad assembly 44 defines a ridge 110 which forms a secondary pivot axis, as best shown in FIG. 6. When assembled, ridge 110 is juxtaposed to a land 47 defined in housing 32. Ridge 110 is formed at the intersection of two relatively flat plane portions at 112 and 114. The pivot axis at ridge 110 is substantially parallel to, but spaced apart from, the primary pivot axis defined by trunnions 60A and 60B and cheeks 60.

The secondary pivot axis provided by ridge 110 and land 47 is a feature of vehicle pedals according to an embodiment the present invention to allow for failure of the structural elements that provide the primary pivot axis, namely, trunnions 60A and 60B and cheeks 66. Over the useful life of an automobile, material relaxations, stress and or other aging type changes may occur to trunnions 60A and 60B and cheeks 66. Should the structure of these features be compromised, the pivoting action of brake pad 44 can occur at ridge 110.

Pedal arm 22 has predetermined rotational limits in the form of an idle, return position stop 33 on side 30 and a depressed, open-throttle position stop 36 on side 28 in the case of an accelerator pedal. When pedal arm 22 is fully depressed, stop 36 comes to rest against portion 98 of housing 32 and thereby limits forward movement. Stop 36 may be elastomeric or rigid. Stop 33 on the opposite side 30 contacts a lip 35 of housing 32. Housing 32 is securable to a wall via fasteners through mounting holes 38. Pedal assemblies according to the present invention are suitable for both firewall mounting or pedal rack mounting by means of an adjustable or non-adjustable position pedal box rack.

Magnet assembly 80 has opposing fan-shaped sections 81A and 81B, and a stem portion 87 that is held in a two-pronged plastic grip 86 extending from drum 29. Magnet assembly 80 preferably has two major elements: a specially shaped, single-piece magnet 82 and a pair of (steel) magnetic flux conductors 84A and 84B. Single-piece magnet 82 has four alternating (or staggered) magnetic poles: north, south, north, south, collectively labeled with reference numbers 82A, 82B, 82C, 82D as best seen in FIG. 2. Each pole 82A, 82B, 82C, 82D is integrally formed with stem portion 87 and separated by air gaps 89 (FIG. 1) and 88 (FIG. 3). Magnetic flux flows from one pole to the other—like charge arcing the gap on a spark plug—but through the magnetic conductor 84. A zero gauss point is located at about air gap 88.

Magnetic field conductors 84A and 84B are on the outsides of the magnet 82, acting as both structural, mechanical support to magnet 82 and functionally tending to act as electromagnetic boundaries to the flux the magnet emits. Magnetic field conductors 84 provide a low impedance path for magnetic flux to pass from one pole (e.g., 82A) of the magnet assembly 80 to another (e.g., 82B).

As best shown in FIG. 2, sensor assembly 90 is mounted to housing 32 to interact with magnet assembly 80. Sensor assembly 90 includes a circuit board portion 94 received within the gap 89 between opposing magnet sections 81 A and 81 B, and a connector socket 91 for receiving a wiring harness connector plug. Circuit board 94 carries a pair of Hall Effect sensors 92A and 92B. Hall effect sensors 92 are responsive to flux changes induced by pedal arm lever displacement and corresponding rotation of drum 29 and magnet assembly 80. More specifically, Hall effect sensors 92 measure magnet flux through the magnet poles 82A and 82B. Hall effect sensors 92 are operably connected via circuit board 94 to connector 91 for providing a signal to an electronic throttle control. Only one Hall effect sensor 92 is needed but two allow for comparison of the readings between the two Hall effect sensors 82 and consequent error correction. In addition, each sensor serves as a back up to the other should one sensor fail.

Electrical signals from sensor assembly 90 have the effect of converting displacement of the foot pedal 27, as indicated by displacement of the magnet 82, into a dictated speed/acceleration command which is communicated to an electronic control module such as is shown and described in U.S. Pat. No. 5,524,589 to Kikkawa et al. and U.S. Pat. No. 6,073,610 to Matsumoto et al. hereby incorporated expressly by reference for any purpose.

Referring to FIGS. 2 and 3, it is a feature of the present invention that the semi-circular contours of contact surface 70 and trunnion portion 62 can be aligned concentrically or eccentrically. A concentric alignment as illustrated in FIG. 4, with reference labels R 1 and R2, results in a more consistent force F_{N} applied between surface 42 and surface face 70 as pedal arm 22 is actuated up or down. An eccentric, alignment as illustrated in FIG. 2, tends to increase the hysteresis effect. In particular, the center of the circle that traces the contour of the surface 70 is further away from the firewall in the rearward direction 74.

The effect of this eccentric alignment is that depression of the footpad 27 leads to an increasing normal force F_{N} exerted by the contact surface 70 against braking surface 42. A friction force F_{f} between the surface 70 and surface 42 is defined by the coefficient of dynamic friction multiplied by normal force F_{N}. As the normal force F_{N} increases with increasing applied force Fₐ at footpad 27, the friction force F_{f} accordingly increases. The driver feels this increase in his/her foot at footpad 27. Friction force F_{f} runs in one of two directions along face 70 depending on whether the pedal lever is pushed forward 72 or rearward 74. The friction force F_{f} opposes the applied force Fₐ as the pedal is being depressed and subtracts from the spring force F, as the pedal is being returned toward its idle position.

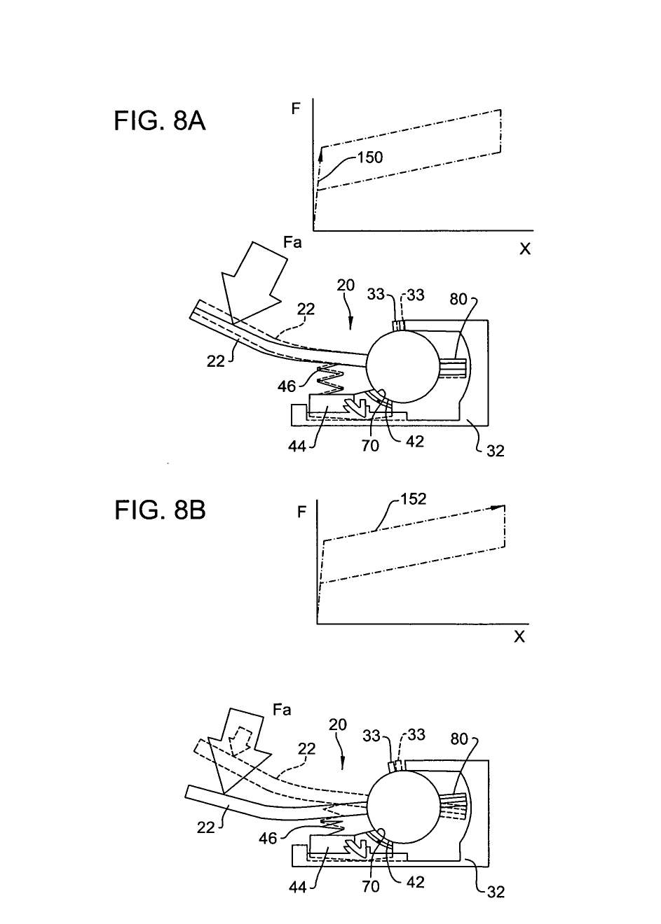

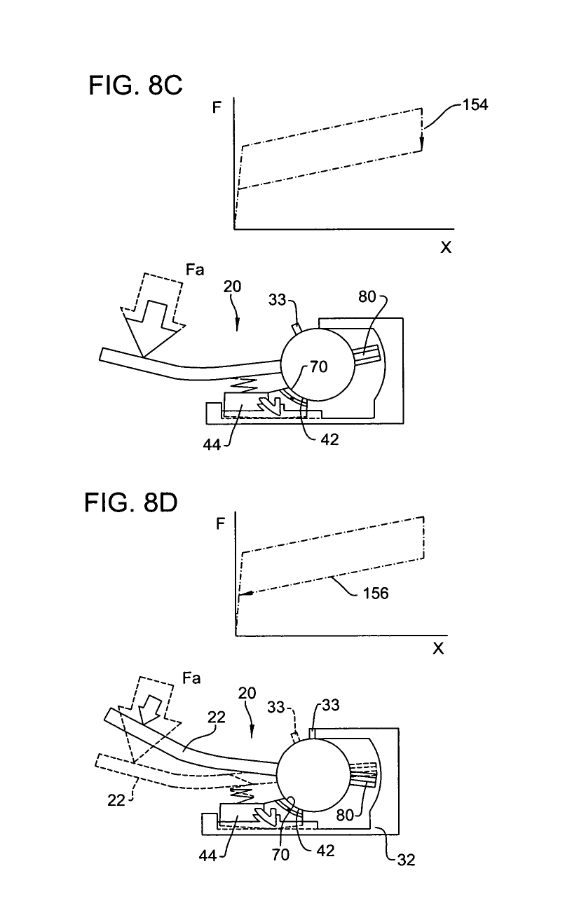

FIGS. 8A, 8B, 8C, 8D contain a force diagram demonstrating the directionally dependent actuation-force hysteresis provided by accelerator pedal assemblies according to the present invention. In FIGS. 8A through 8D, the y-axis represents the foot pedal force Fₐ required to actuate the pedal arm, in Newtons (N). The x-axis is displacement of the footpad 27. Path 150 represents the pedal force required to begin depressing pedal arm 22. Path 152 represents the relatively smaller increase in pedal force necessary to continue moving pedal arm 22 after initial displacement toward mechanical travel stop, i.e., contact between stop 36 and surface 98. Path 154 represents the decrease in foot pedal force allowed before pedal arm 22 begins movement toward idle position. This no-movement zone allows the driver to reduce foot pedal force while still holding the same accelerator pedal position. Over path 156, accelerator pedal assembly 20 is in motion as the force level decreases. FIGS. 8A, 8B, 8C, 8D combine a force-displacement graph with simplified schematics showing selected features of accelerator pedals according to the invention. The schematic portion of FIG. 8A illustrates the status of accelerator pedal apparatus 20 for path 150 when initially depressed. FIG. 8B illustrates the status of apparatus 20 for path 152 when increasing pedal force causes relatively greater pedal displacement. FIG. 8C illustrates the status of apparatus 20 for path 154 when pedal force can decrease without pedal arm movement. Finally, FIG. 8D illustrates the status of apparatus 20 for path 156 as pedal arm 22 is allowed to return to idle position.

FIGS. 8A through 8D describe pedal operation according to an embodiment of the present invention over a complete cycle of actuation from a point of zero pedal pressure, i.e., idle position, to the fully depressed position and then back to idle position again with no pedal pressure. The shape of this operating curve also applies, however, to midcycle starts and stops of the accelerator pedal. For example, when the pedal is depressed to a mid-position, the driver still benefits from a no-movement zone when foot pedal force is reduced.

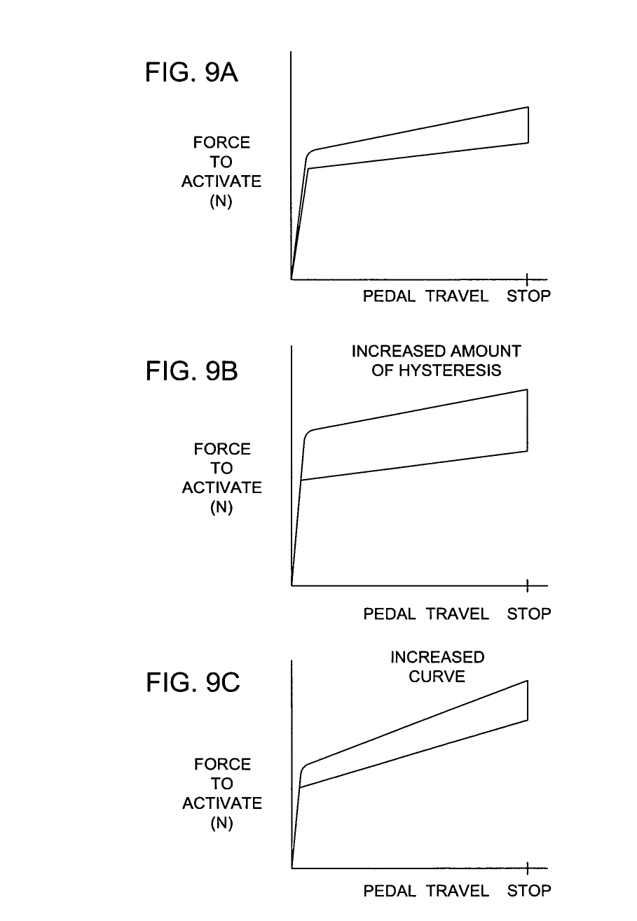

FIGS. 8A through 9C are additional force diagrams demonstrating the directionally dependent actuation-force hysteresis provided by accelerator pedal operation according to the present invention. FIG. 9A is a reproduction of the force diagram of FIGS. 8A through 8D for juxtaposition with FIGS. 9B and 9C. As compared to the accelerator pedal assembly described in FIG. 9A, the assembly described by FIG. 9B offers a larger no-movement zone 154, i.e., increased hysteresis. In an embodiment, pedal force can be reduced 40 to 50 percent before pedal arm 22 begins to move towards idle. FIG. 9C is the operating response for an accelerator pedal requiring a greater increase in foot pedal force to actuate the pedal arm. In other words, FIG. 9C describes an accelerator pedal according to an embodiment of the present invention having a relatively “stiffer” tactile feel.

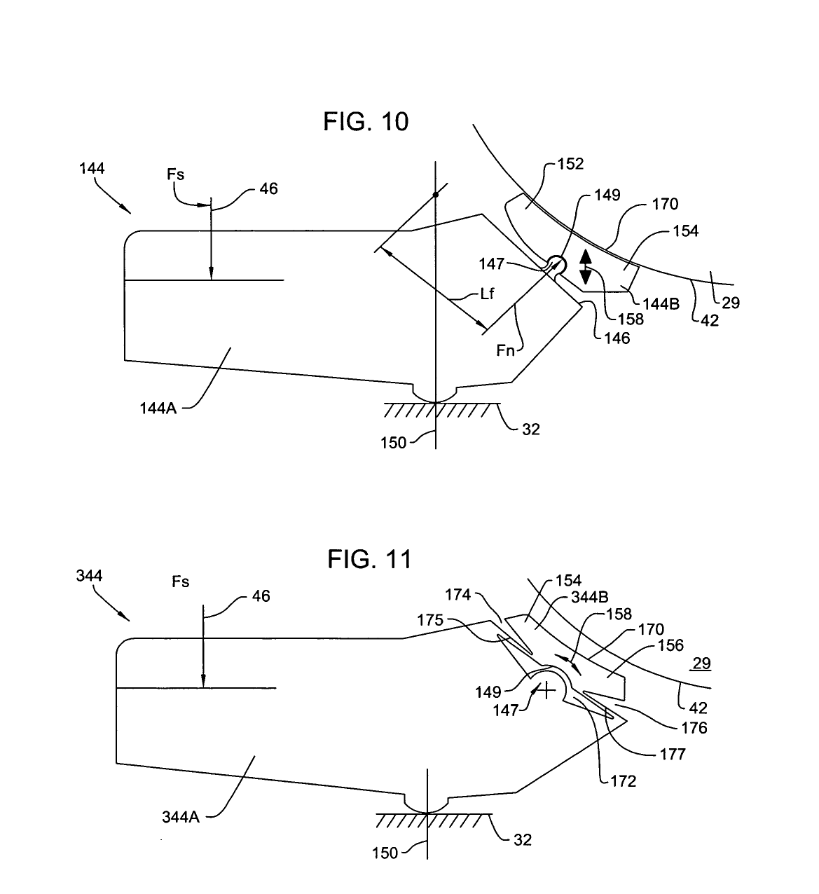

FIG. 10 shows an embodiment of a brake pad assembly 144 that includes a pivoting base 144A and a pivoting contact portion 144B. Base 144A includes a surface 146 facing and spaced from the rounded braking surface 42. A rounded projection or connection point 147 extends outwardly from surface 146. In the illustrated embodiment, the connection point 147 is an integrally formed projection. Contact portion 144B includes a recess 149 adapted to receive the connection point 147. The contact portion 144B is pivotally fixed to the base 144A. In an embodiment, the contact portion 144B is fixed to base 144A by a press fit. Contact 144B is centrally connected to the base 144A and has two segments or arms 152, 154 extending outwardly from the central connection. Each segment 152, 154 is spaced from the adjacent face of base 144A such that one segment can move toward the base 144A with the other segment moving away from the base 144A to allow the contact portion 144B to pivot relative to base 144A, e.g., in the direction of arrow 158. The contact portion 144B also pivots with base 144A about the primary pivot axis 150. The primary pivot axis 150 is formed by trunnions and cheeks (not shown in FIG. 10) as described herein. Contact portion 144B has a rounded contact surface 170. Rotation of the base 144A in response to downward spring force 46 as shown in FIG. 10 results in the contact surface 170 moving into contact with the surface 42 of pedal arm drum portion 29. The contact portion 144B acts as a shoe and pivots about connection point 147 so that its contact surface 170 maximizes its area in contact with the drum portion surface 42. The pivotal contact portion 144B more accurately maintains the force (normal friction force F_{N}) at the connection point between the contact portion 144B and base 144A, i.e., through the projection 147, regardless of variations in manufacturing tolerances. As a first result, the normal force is substantially constant regardless of manufacturing tolerances. Moreover, a more full area of surface 170 is available for wear and contact. As a secondary result, the pivoting of the contact portion 144B allows the contact friction area to be maximized as the contact surface 170 mates with the drum 29. Brake pad assembly 144 can be formed from injection molded plastic.

FIG. 11 shows an embodiment of a brake pad assembly 344 that includes a base 344A and a contact portion 344B pivotally connected to the base 344A. In this embodiment, the contact portion 344B is fabricated from a block of material that is integral with the base 344A. In an embodiment, the material is an engineered polymer that has sufficient rigidity and durability to be used in vehicle applications. A through aperture 172 is cut into the integral base/contact portion to form a projection 147 centrally on the surface of base 344A that will face the drum surface 42 and a substantially matching cavity 149 in contact portion 344B. The aperture 172 further extends upwardly and downwardly from the projection 147. Aperture 172 has a greater width adjacent the projection 147. Aperture 172 decreases in width as it extends from the central projection. Aperture 172 extends from one side to the other side of base 344A with the base surface facing the drum portion 29 and contact portion 344B being a solid surface. An upper recess 174 is intermediate the base 344A and the upper arm 154 of contact portion 344B. The upper recess is closed adjacent the cavity 149 and open at the upper surface of the base 344A. A web 175 of the base material remains intermediate the aperture 172 and upper recess 174. In an embodiment, the web 175 is a solid. In an embodiment, the web 175 has apertures therein. A lower recess 176 is intermediate the base 344A and a lower arm 156 of contact portion 344B. The lower recess 176 is closed adjacent the cavity 149 and open at the lower surface of the base 344A. A web 177 of the base material remains intermediate the aperture 172 and lower recess 176. In an embodiment, the web 177 is a solid. In an embodiment, the web 177 has apertures therein. The contact portion, friction surface 170 is brought into contact with the drum surface 42 as described herein. Cavity 149 can contact projection 147 after assembly. The contact portion 344B is a shoe that pivots about an axis generally positioned in the projection 147 and generally in the directions shown by arrow 158. As a result, the contact friction area is maximized and remains relatively constant independent of manufacturing tolerances. Moreover, a more full area of surface 170 is available for wear and contact. Similar to the FIG. 4 embodiment, the pivotal contact portion 344B more accurately maintains the force (normal force F_{N}) central to the contact portion 344B, i.e., at cavity 149 and projection 147, regardless of variations in manufacturing tolerances. The force is also transmitted from the contact portion 344B through webs 175, 177 to base 344A if the contact portion does not contact projection 147. If contact portion 344B rests on projection 147 during activation, then the force principally transmits through the projection 147 to base 144A. As a result, the lever force is substantially constant regardless of manufacturing tolerances.

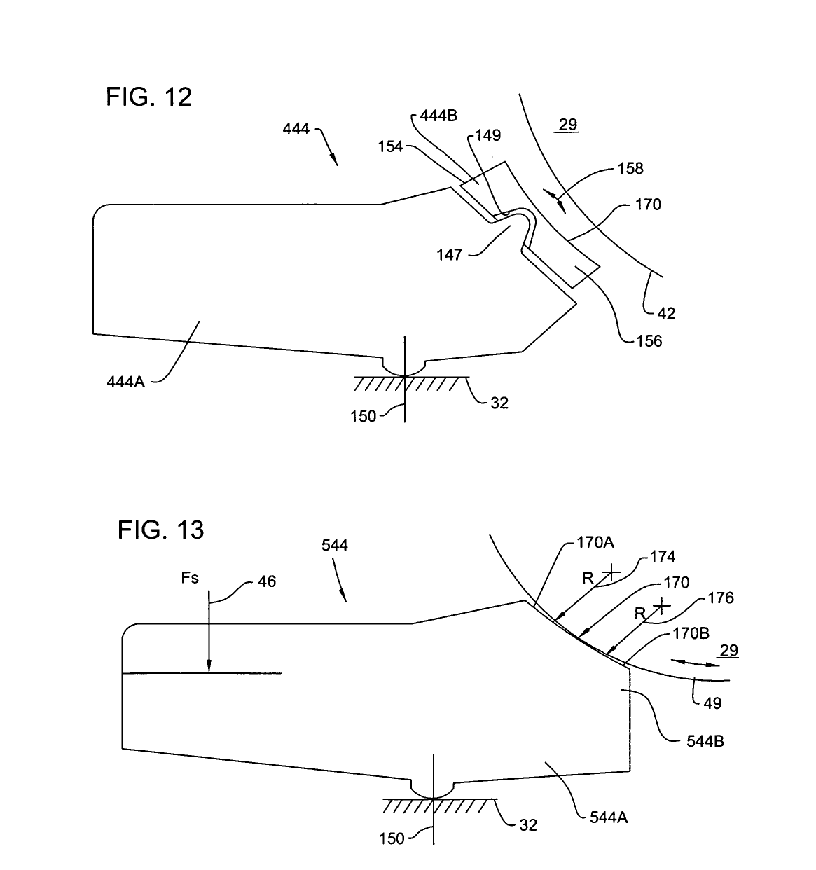

FIG. 12 shows an embodiment of a brake pad assembly 444 that includes a base 444A and a contact portion 444B pivotally connected to the base 444A. In this embodiment, the contact portion 444B is a separate component of the assembly 444. Base 444A includes a projection 147 adapted to be received in a cavity 149 of contact portion 444B. In this embodiment, the projection 147 has a height greater than the depth of the cavity 149, such that a gap separates the bottom surface of contact portion 444B from the adjacent surface of base 444A. This allows the contact portion 444B to pivot on the projection 147 relative to base 444A. The distance between the contact surface 170 and drum surface 42 is less than the depth of cavity 149 so that the contact portion 444B can not fall off the projection 147 when the contact portion 444B is in the idle position of the pedal assembly. This embodiment operates essentially the same as described herein to provide a tactile feedback to the user.

FIG. 13 shows an embodiment of a brake pad assembly 544 that includes a base 544A and a contact portion 544B. In an embodiment, the contact portion 544B is fixed to the base 544A. The contact surface 170 includes a plurality of contact surfaces 170A, 170B, each with a separate radius. In the illustrated embodiment the number of contact surfaces is two. The radius 174 of the upper contact surface 170A is spaced from the radius 176 of lower contact surface 170B. Accordingly, the contact surface 170 is more likely to contact the drum surface 49 in a central area. It will be recognized that the plurality of contact surfaces 170A, 170B, etc., could be positioned on any of the other embodiments described herein. While contact surface 170 was shown with two contact surfaces, more or fewer contact surfaces could also be used.

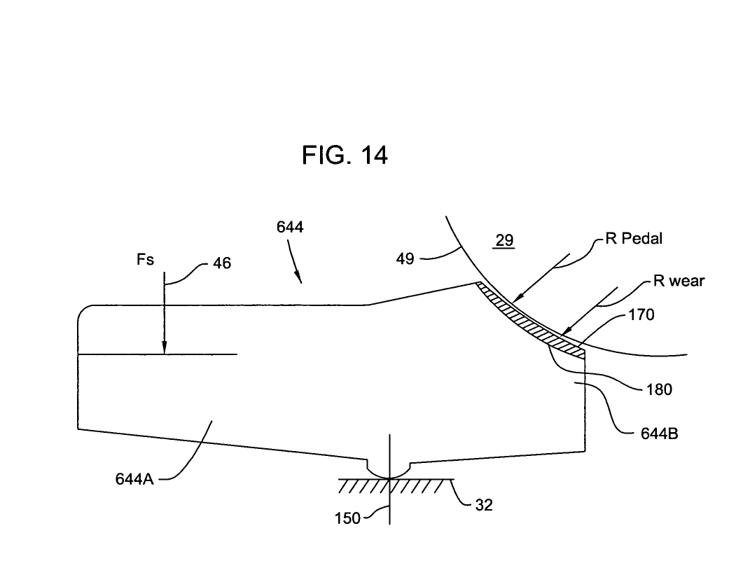

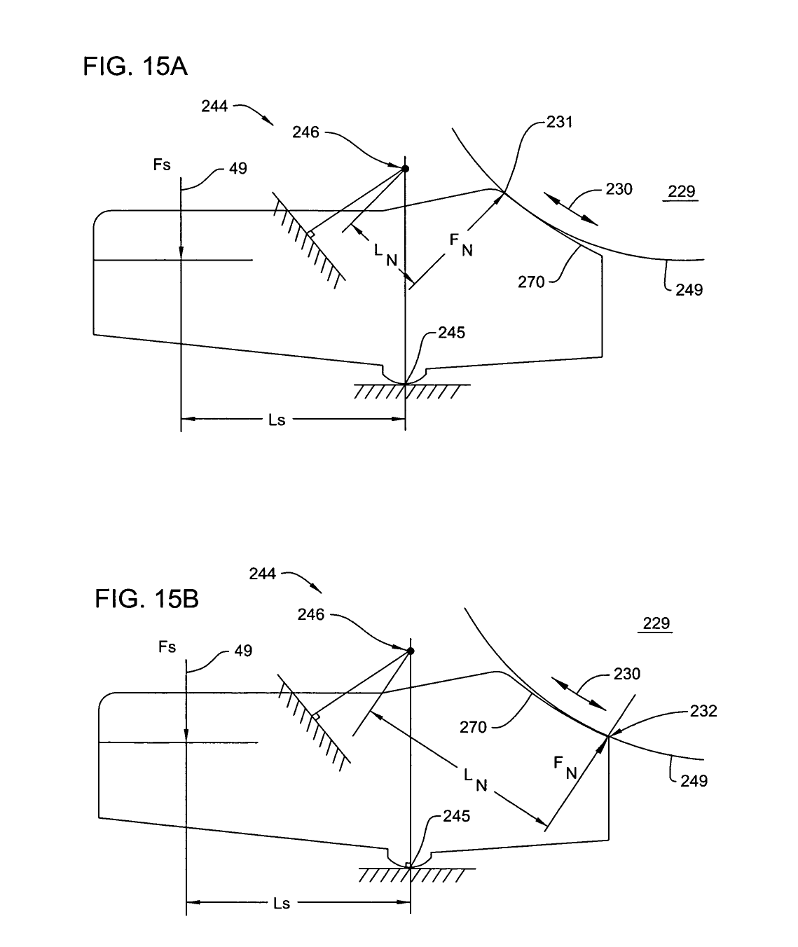

FIG. 14 shows an embodiment of a brake pad assembly 644 that includes a base 644A and a contact portion 644B. The contact portion 644B includes a wear section 180 that forms the contact surface 170. The contact surface 170 of the wear section 180 has a radius Rwear that is greater than the radius Rpedal of the drum surface 49. In other words, the radius of the friction lever surface Rpedal is less than the radius of the pedal lever Rwear. This in turn narrows the possible contact area of the contact surface 170 to the drum surface 49, which causes the contact area to start near the center of the contact surface 170 over time. As a result, the lever forces will tend toward the desired design quantity. This will result is a more consistent friction force that a user will feel. Base 644A and contact portion 644 can be formed from injection molded plastic.

Numerous variations and modifications of the embodiments described above may be effected without departing from the spirit and scope of the novel features of the invention. It is to be understood that no limitations with respect to the specific system illustrated herein are intended or should be inferred. It is, of course, intended to cover by the appended claims all such modifications as fall within the scope of the claims.

I claim:

1. A pedal assembly, comprising:
a housing;
an elongated pedal arm having a rotatable drum defining a braking surface and rotatably mounted in the housing, the pedal arm being movable between an idle, first position and a second position;
a brake pad assembly having a pivoting base and a contact portion pivotally mounted to the base, the contact portion having a contact surface adapted to frictionally engage the braking surface; and
a biasing device operably coupled to the pedal arm and the brake pad assembly for urging the contact surface into frictional engagement with the braking surface.

2. The accelerator pedal assembly of claim 1, wherein the base includes a projection, and wherein the contact portion includes a recess adapted to receive the projection and allow the contact portion to pivot relative to the base.

3. The accelerator pedal assembly of claim 2, wherein the recess of the contact portion is larger than the projection such that the contact portion is free to pivot in any direction.

4. The accelerator pedal assembly of claim 2, wherein the recess and projection form a press fit such that the contact portion pivots in a direction substantially tangential to the braking surface of the drum.

5. The accelerator pedal assembly of claim 1, wherein the pivoting base is mounted to the housing.

6. The accelerator pedal assembly of claim 1, wherein the base includes a first web connected at an inward first end to the contact portion and a second web connected at an inward first end to the contact portion.

7. The accelerator pedal assembly of claim 6, wherein the contact portion includes a cavity inward of the first ends of the first and second webs, and wherein the base includes a projection aligned with the cavity.

8. The accelerator pedal assembly of claim 7, wherein the contact portion includes a first arm extending in a first direction from the first end of the first web and a second arm extending in a second direction from the first end of the second web, the first arm being spaced from the first web, and the second arm being spaced from the second web.

9. The accelerator pedal assembly of claim 1, wherein the contact surface of the contact portion pivots such that it substantially mates to the braking surface.

10. The accelerator pedal assembly of claim 1, wherein the contact surface has at least 75% of its surface in contact with the braking surface with the pedal arm moved from the first, idle position.

11. The accelerator pedal assembly of claim 1, wherein the contact surface has a first substantially constant radius of curvature.

12. The accelerator pedal assembly of claim 11, wherein the contact surface has a second substantially constant radius of curvature.

13. The accelerator pedal assembly of claim 12, wherein the braking surface has a substantially constant radius of curvature substantially equal to at least one of the first or second substantially constant radius of curvatures of the contact surface.

14. The accelerator pedal assembly of claim 11, wherein the contact portion includes a wear surface adapted to conform to the braking surface over time such that a normal friction force moves to a given center value over time.

15. The accelerator pedal assembly of claim 11, wherein the brake pad assembly includes opposed trunnions adapted to mount on the housing and define a primary pivot axis.

16. The accelerator pedal assembly of claim 1, wherein the housing includes a sensor adapted to read displacement of the pedal arm and produce an electrical signal based on the displacement.

17. The accelerator pedal assembly of claim 16, wherein the pedal arm includes a magnet and the housing includes a Hall effect sensor adapted to read the magnetic field produced by the magnet.

18. The accelerator pedal assembly of claim 1, wherein the biasing device includes a spring under pressure to urge the pedal arm to the first, idle position.

19. A pedal assembly, comprising:
a housing;
an elongated pedal arm having a rotatable drum defining a braking surface and rotatably mounted in the housing, the pedal arm being movable between an idle, first position and a second position;
a brake pad having means for contacting the drum and for keeping the normal friction force centrally located on a face of the brake pad; and
a biasing device operably coupled to the pedal arm and the brake pad assembly for urging the contact surface into frictional engagement with the braking surface.

20. The accelerator pedal assembly of claim 19, wherein the housing includes a sensor adapted to read displacement of the pedal arm and produce an electrical signal based on the displacement; and wherein the biasing device includes a spring under pressure to urge the pedal arm to the first, idle position.

21. A pedal assembly, comprising:
a housing;
an elongated pedal arm supported in the housing for rotational movement, the pedal arm being movable between a first position and a second position;
a rotatable drum mounted to the pedal arm, the drum defining a braking surface;
a brake pad assembly mounted in the housing, the brake pad assembly having a pivoting base;
a pivoting contact portion pivotally mounted to the base, the contact portion having a contact surface adapted to frictionally engage the braking surface; and
a spring set between the pedal arm and the brake pad assembly for urging the contact surface into frictional engagement with the braking surface.

22. A pedal assembly, comprising:
a housing;
an elongated pedal arm supported in the housing for rotational movement between a first position and a second position;
a drum mounted to the pedal arm, the drum having a braking surface;
a brake pad assembly mounted in the housing, the brake pad assembly having a first pivoting portion and a second pivoting contact portion;
the second pivoting contact portion being pivotally mounted to the base, the second contact portion having a contact surface adapted to frictionally engage the braking surface; and
a spring set between the pedal arm and the first pivoting portion, the spring urging the contact surface into frictional engagement with the braking surface.

23. A pedal assembly, comprising:
a housing;
an elongated pedal arm supported in the housing for rotational movement, the pedal arm being movable between a first position and a second position;
a rotatable drum mounted to the pedal arm, the drum defining a braking surface;
a brake pad assembly mounted in the housing, the brake pad assembly having a pivoting base;
a wear surface mounted to the base, the wear surface adapted to frictionally engage the braking surface; and
a spring set between the pedal arm and the brake pad assembly for urging the wear surface into frictional engagement with the braking surface.

24. The pedal assembly of claim 23, wherein the wear surface has a first radius of curvature.

25. The pedal assembly of claim 23, wherein the wear surface includes a first and second contact surface.
